(19) United States
(12) Patent Application Publication
(10) Pub. No.: US 2003/0061688 A1
(43) Pub. Date: Apr. 3, 2003

(54) Ergonomic binder clip

(76) Inventors: Maria Del Carmen Rodriguez, Houston, TX (US); Bonnie K. Smith, Cat Springs, TX (US)

Correspondence Address: William D. Durkee, 11802 Village Park Circle, Houston, TX, 77024-4418, US

(21) Appl. No.: 10/259,682

(22) Filed: Sep. 27, 2002

Related U.S. Application Data
(60) Provisional application No. 60/325,645, filed on Sep. 28, 2001.

(51) Int. Cl. B42F 1/02; B42F 1/00

(52) U.S. Cl. 24/67.5; 24/67 R; 24/537

(57) ABSTRACT

A binder clip for holding sheets of paper or other items comprises a clamp including a flexible hinge and gripping surfaces on the inside of the clamp which hold the paper sheets when the clamp is closed, and a spring which slides over the front and back surfaces of the clamp from the location of the hinge to force the clamp closed and push the gripping surfaces toward each other for binding the items together.

### CLAIM TO PRIORITY

This application claims priority based on provisional application serial No. 60/325,645 which was filed in the United States on Sep. 28, 2001.

### BACKGROUND OF THE INVENTION

The present invention relates generally to a clip, binder, or clamp used for binding or holding papers and other materials together in an organized manner. Existing binder clips for sheets of paper require too much strength and energy for actuation, particularly by persons with disabilities, arthritis, etc. Existing binder clips for paper are made of metal and have sharp metal edges which scratch desk surfaces made of wood or glass.

### THE INVENTION

The primary objective of the present invention is to provide a binder clip for paper which is durable, economical, and ergonomically designed to be significantly easier and less painful to use in everyday requirements, particularly in the normal office environment. The efficiency and ease in opening and closing also provides a better design for storage and shipping of the binder clips. The preferred material of construction—hard durable plastic and an elastic metal or plastic spring clip—can be colored to be more appealing to the eye and to provide color coding for importance, filing order, or other identification. Because of the ease of opening and closing, the binder clip of the invention does not require enough pressure to cause unexpected spring release and possible injury.

The invention provides a single binder which is finger-actuated for holding one or more entities such as sheets of paper and is finger releasable to release such entities. The binder comprises a clamp having opposing jaws attached along a rotatable joint with the back side of the clamp having a slideway which is substantially perpendicular to the axis of rotation of the joint, and the front side having a ramp on its outer surface.

A closing spring is connected to the clamp along one or more surfaces which mate with the slideway to form a slideable connection substantially perpendicular to the axis of rotation of the joint between an open position where the clamp is open and a closed position when the spring is slid over the ramp to force the clamp into a closed, binding position. The opposing jaws have opposing gripping surfaces which preferably are substantially smooth and which grip the one or more entities by substantially non-marking friction. The spring is releasable by finger actuation to slide the spring back over the ramp to free the clamp from its closed binding position.

The opposing gripping surfaces should be free of teeth, and at least one of the opposing gripping surfaces is substantially flat, or has an arcuate shape. The clamp including the joint is preferably composed of a hard plastic material and the spring is composed of hard plastic having elasticity to form a spring. The gripping surfaces may be layers of a plastic gripping material which is different from the hard plastic material of the clamp. The slideway may be a channel having opposing side grooves to allow the spring to slide along the channel with ears which slide in the opposing side grooves. The slideway has one or more stops near the rotatable joint to keep the spring from becoming disconnected from the clamp. The opposing side grooves may have stops near the joint to keep the ears and the spring from escaping the slideway.

The spring may have flexing space between the ears to allow the ears to be flexed towards each other and moved past the stops to enter the grooves. The ears should be shaped to allow entry into the grooves, but to restrict removal from the grooves. The clamp can have a detent on the front side which can engage a catch on the spring to hold the spring against the clamp in the closed position.

The clamp is shaped for finger-actuation and the front side of the clamp may have a recessed surface to enhance access to the spring for thumb-actuation to release the spring from the ramp and free the clamp from its closed binding position.

The binder of the invention includes preferably a clamp which is a single molding of plastic material, including the joint. The binder of the invention is preferably a single entity composed of the clamp and the spring, without attachment to other clamps or clamping mechanisms.

The present invention will be more fully understood from the following detailed description taken in conjunction with the accompanying drawings.

### BRIEF DESCRIPTION OF THE DRAWINGS

FIG. 1 is a back perspective view of the binder clip in an open position in accordance with the invention.

FIG. 2 is a front perspective view of the binder clip of FIG. 1 in an open position.

FIG. 3 is a top perspective view of the binder clip of FIG. 1 in a closed position.

FIG. 4 is a rear perspective view of the binder clip of FIG. 1 in a closed position.

FIG. 5 is a perspective view of the interior of the binder clip of FIG. 1 in an open position with gripping layers 16 and 18 removed.

FIG. 6 is a rear perspective view of an alternative embodiment in a closed position.

FIG. 7 is a side perspective view of the binder clip of FIG. 6 in an open position.

### DESCRIPTION OF ILLUSTRATIVE EMBODIMENTS

The illustrative embodiments described herein provide a binder clip, holder, or clamp which is lightweight, economical, eye pleasing and ergonomically designed to tightly bind papers and other items while being easy to use and eye appealing for special purposes. While illustrated by means of specific illustrative embodiments of a binder clip, the illustrative embodiments will also find use in a wide-range of applications calling for binding together or holding of items such as photographs, notes, lists, name tags, etc. Therefore, the illustration by means of a binder clip for papers is meant to be illustrative and not limiting, although the binder is particularly suited for binding or clipping sheets of paper.

The binder clip can have a magnetic portion or other attachment mechanism such as hook and loop for holding items like papers, pictures, pot holders, and hand towels on a refrigerator, stove, blackboard, cork board, peg board, and the like. It may also be useful as hair clips or clips for closing bags and containers. For hanging pictures, calendars, name tags, etc., a ribbon can be entered through the interior of the binder clip or under the spring clip before it is pushed down on the gripping support to create the binder.

In general, a binder clip in accordance with the invention comprises a gripping clamp preferably made of a pair of gripping supports or jaws connected by a joint or hinge to allow the gripping supports or jaws to move towards and away from each other. The interior surfaces of the gripping supports or jaws may have ridges, bumps, a tacky surface, etc., to help hold paper or other material between them, but the gripping surfaces should not have teeth or other surfaces which mark or mar the surface of the materials to be bound. The gripping surfaces are preferably smooth and flat or arcuate to provide a non-marking surface. Small grooves may be molded into the jaws for helping to hold a gripping layer on the jaws.

A closing spring is slideable over the gripping clamp to hold and force the gripping jaws of the clamp together, and to hold the paper or other material between the gripping surfaces of the jaws. The clamp has outside surfaces for receiving a releasable spring to force the gripping surfaces toward each other. The closing spring may be released from holding the gripping surfaces together by finger (including thumb) pressure on a pressure release surface to release and slide the spring to release the force against the gripping clamp.

The gripping clamp preferably has a flat slide surface on the outside of one jaw to guide one leg of the spring clip and an arcuate slide surface or ramp on the outside of the other to cause a leg of the spring clip to engage and force the gripping jaws together to bind the paper or other material between the jaws into a fixed position.

At least one of the slide surfaces has a guide to keep the spring in position as it is set and/or released from the gripping clamp. The guide may comprise a recess, depression, or cavity with side surfaces or grooves, such as parallel side surfaces or grooves which keep the spring clip sliding in a proper relation with the gripping clamp.

The arcuate slide surface preferably has a catch or edge across the arcuate slide surface which forms a lock, detent, or catch with a catch, lock, hook or edge on the spring.

An enlarged finger pressure flange or section on the end of the arcuate leg of the spring clip can be employed to release the lock by exertion of thumb (finger) pressure and slide the spring clip away and release the interior gripping surfaces of the gripping supports.

One side of the gripping clamp preferably has a holding mechanism or restraint which keeps the gripping clamp and the spring clip together when they are not in a forced holding relationship. A slat over and across a recess for one leg along with a projection on a leg of the spring clip can be employed to keep the two parts together. Extended ears on a leg of the spring clip which fit into grooves on the parallel sides of the recess are preferably employed. Other mechanisms may also be used, or the binder clip may be made in two separate parts which are mated at the time of use, such as by molding cooperating cylinders on the jaws which can be fitted together to accept a pin to form a hinger.

The binder clip preferably has a finger holding or gripping area on the gripping clamp to allow holding the binder while pushing against and releasing the spring clip from the gripping clamp. This finger holding area is preferably outside of the area for the sliding surfaces between the spring clip and the gripping clamp.

The paper binder clip of the present invention is preferably a single or individual entity or body which comprises two components—a hinged clamp which is not biased together on its own and a spring clip which slides over the hinged clamp after the clamp is in proper clamping position to close the clamp and force it to bind or hold the paper and similar materials in position between the clamp.

In addition, the spring clip does not have to have flat legs. The legs could be cylindrical in shape or partially so, as in the shape of a bobby pin, to force the gripping members together. In such event, the cylindrical legs or leg could slide through a cylinder or a semicircular conduit in the gripping clamp for alignment and restraint from separation. The other leg of the spring clip could be flat or similar in shape. The clip can be made of metal or metal covered with a plastic. Plastic on the outside is preferred to minimize scratching of surfaces on which the binder is placed, such as desk tops and table tops.

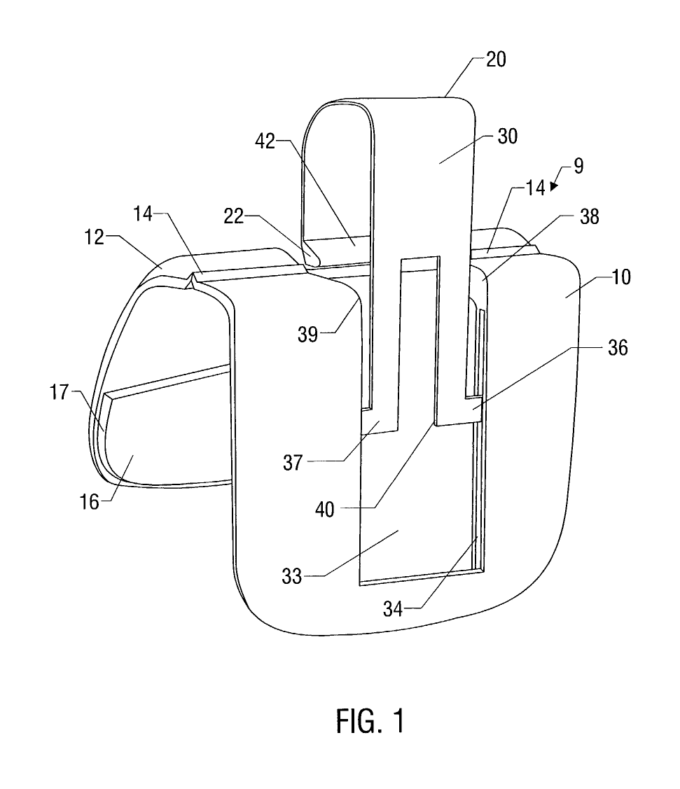

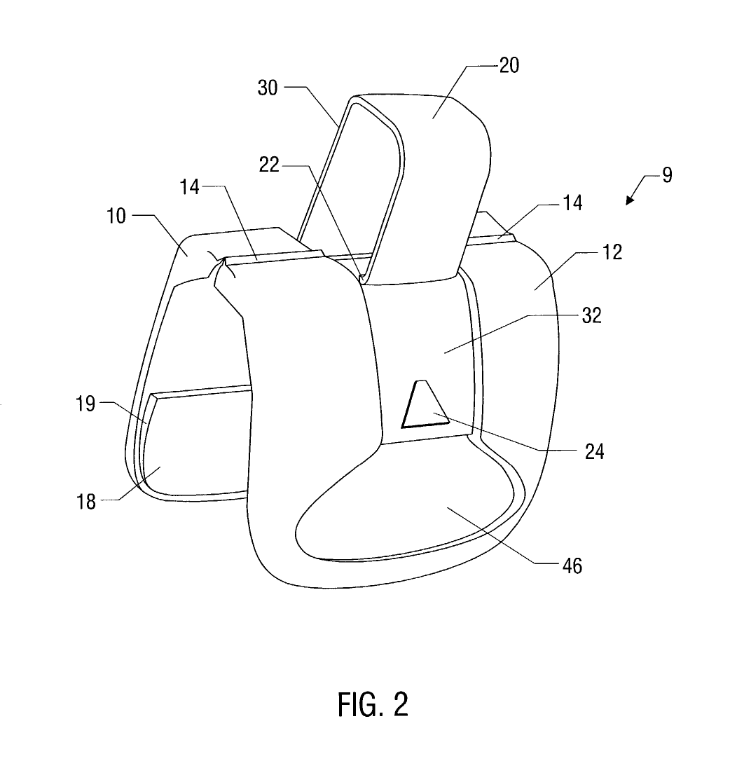

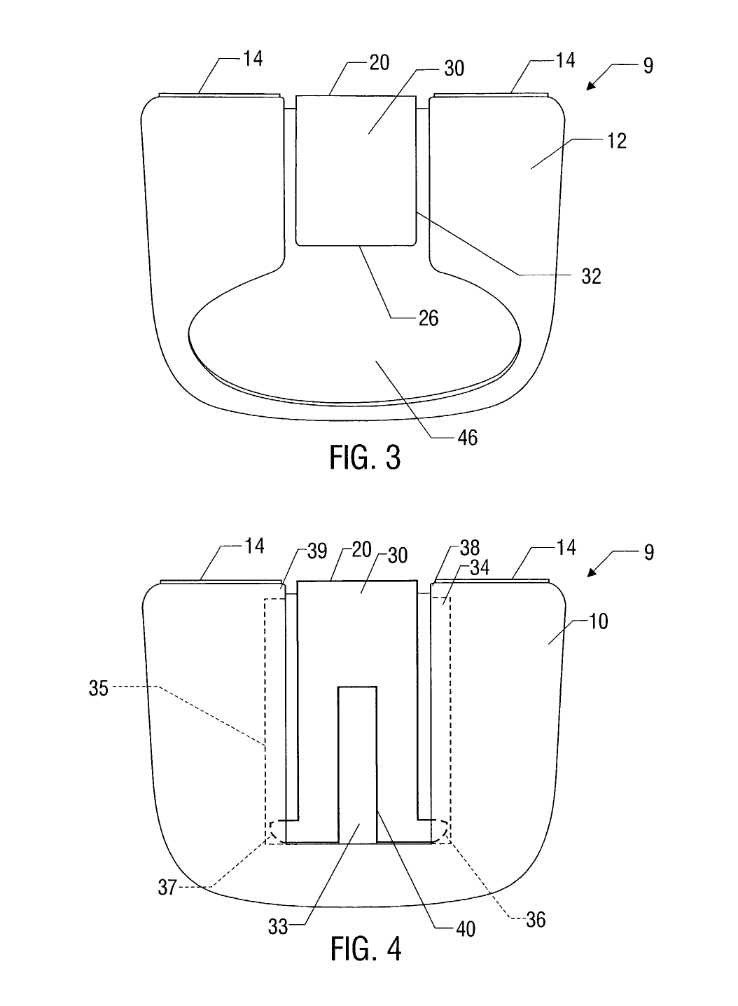

With reference to FIGS. 1 to 5 of the drawings, a lightweight, durable binder clip 9 comprises two gripping jaws or supports 10 and 12 connected by a flexible joint or hinge 14. For integral, molded shapes, the joint is referred to as a “living hinge.” Each inner side of the supports 10 and 12 contain clamping surfaces 16 and 18 which grip when closed. Clamping surfaces 16 and 18 are the outside surfaces of layers 17 and 19 which are affixed to the jaws 10 and 12. Each outer side of the supports 10 and 12 provides a guide area for guiding an actuating spring 20, preferably made of durable spring-like plastic, being pushed down to lock the supports 10 and 12 together in a gripping relationship. The spring clip 20 when pulled or pushed up away from the opposing gripping jaws or supports 10 and 12 cause the binder clip 9 to release and relax the gripping supports 10 and 12 to open the binder clip 9.

The actuating spring 20 is preferably made of a material with a resilient, elastic spring action such as spring plastic or metal so that when it is forced down to bind the jaws or supports 10 and 12 it overlaps and catches a shoulder or detent 24 provided on the front outer surface of the support 12 to hold the binder in place and clamp it tightly to the papers or other items or materials. The tension in the actuating spring 20 self-adjusts the tightness on the supports 10 and 12 for the thickness of the paper or other item to be bound and requires only light pushing from the top of spring 20 to close the binder clip 9. The shoulder 22 on the spring 20 is shaped so that a push on it from the bottom end 26, such as by a finger or thumb, slides the shoulder or catch 22 over the corresponding shoulder or detent 24 and causes the binder clip 9 to relax and to open, thereby causing no pain or stress in the fingers or the hand, while opening the binder clip 9. The binder clip 9 is ergonomically better for persons suffering with weakness in the hands and wrist and with hand ailments such as arthritis, digititis, carpal tunnel, or having missing digits, even missing limbs.

With reference to FIGS. 1 to 5, the spring 20 preferably has a leg 30 on the back side of jaw or support 10 which slides in a retaining slot or channel 33 formed in the support 10. Retaining slot 33 has opposing grooves 34 and 35 which accept and guide ears 36 and 37 along their length. Opposing grooves 34 and 35 have stops 38 and 39 at their ends near the joint 14. Stops 38 and 39 keep the ears 36 and 37 from disconnecting from the grooves 34 and 35. The ears 36 and 37 are shaped along with flexing compression space 40 to allow the leg 30 to compress inwardly and slide by the stops 38 and 39 during manufacture. After manufacture the ears are not easily removed from the grooves 34 and 35.

The shoulder 22 is preferably shaped to have a surface 42 which mates with an inclined ramp 32 on the jaw or support 12. The shoulder 22 can engage the detent 24 to keep the spring 20 biased against the jaws 10 and 12.

A thumb depression 46 on the outside of support 12 may be used to provide space to aid pushing the spring clip 20 with its catch 22 over the detent 24 and the inclined ramp 32 on the gripping jaw 12.

The gripping jaws or supports 10 and 12 are preferably held together in a flexible, moveable relationship by a joint or hinge 14 to form a U-shaped gripping binder, clamp, or saddle which can bind one or more items between its opposing gripping surfaces. This U-shaped gripping binder or saddle is preferably made of a plastic which is sufficiently strong to make substantially rigid opposing gripping surfaces but which can be formed thinner to make the flexible hinge. Preferably, the opposing supports and the flexible joint or. hinge are molded from a suitable plastic in one integral piece according to known techniques or to techniques which may be developed. Known plastics may be used or others which become known and which satisfy the desired nature of the structure. Preferred plastics include thermoplastics which can be injection molded, but which can be sufficiently rigid and/or elastic to function as the parts of the binder clip of the invention. Plastics for consideration include abs, abs/nylon, abs/tpu, nylon 6, nylon 6/6, polycarbonate, pc/abs, pps, polypropylene, polysulfone, polyurethane, polyester, liquid cristal polymer, pvc, san, tpe, tpu, tpr, ultem, filled and unfilled grades, composites and many other engineering resins. By selecting the appropriate plastic or composite, and the appropriate molding process, a wide range of surface finish, elasticity, color, and dimensional specifications can be achieved.

A binder clip for paper should include a small size and acceptable width, a rough, tacky or ridged surface for gripping paper as long as it does not mark the paper, a clamp and an outer spring clip which are covered with plastic or made from plastic to minimize scratching of desk surfaces, and an improved thumb release surface of the binder clip to release the spring clip from the clamp.

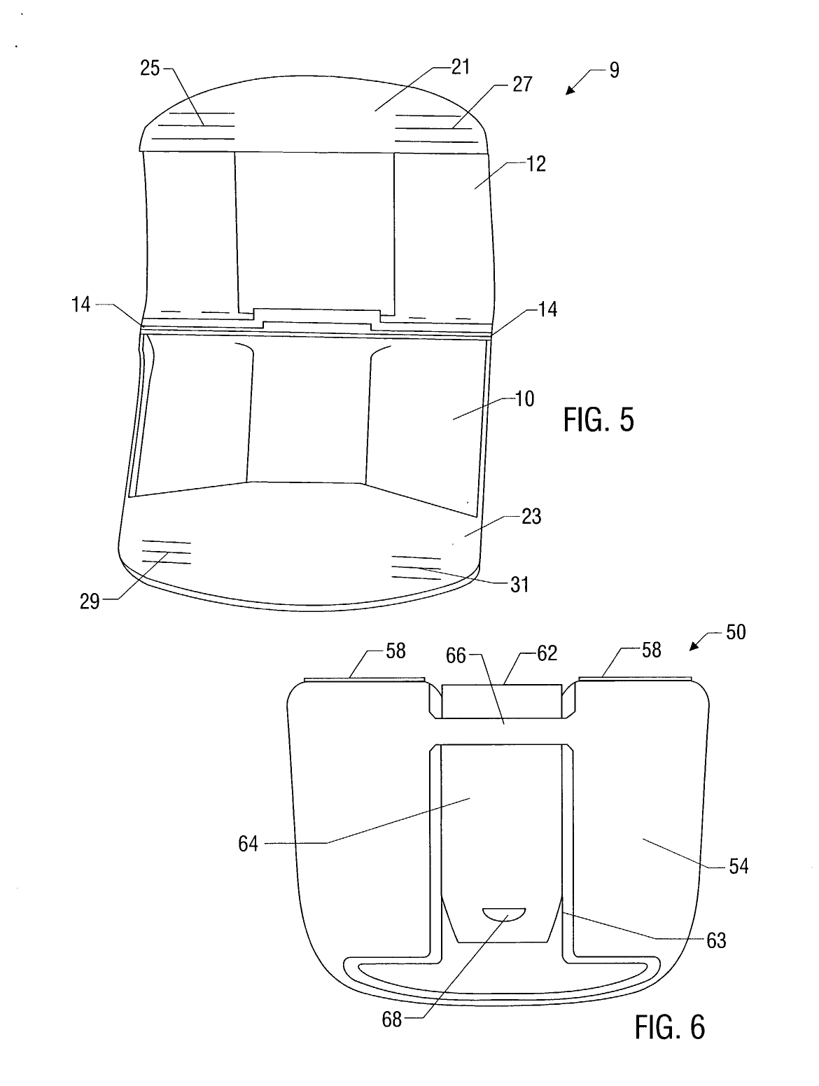

With specific reference to FIG. 5, which is a view of the binder 9 in a fully open position with gripping surfaces 16 and 18 and layers 17 and 19 removed, the interior surfaces 21 and 23 of the jaws 10 and 12 contain small grooves 25, 27, 29, and 31 which can accept part of the layers 17 and 19 and which help hold the layers 17 and 19 to the interior surfaces 21 and 23 of the jaws 10 and 12.

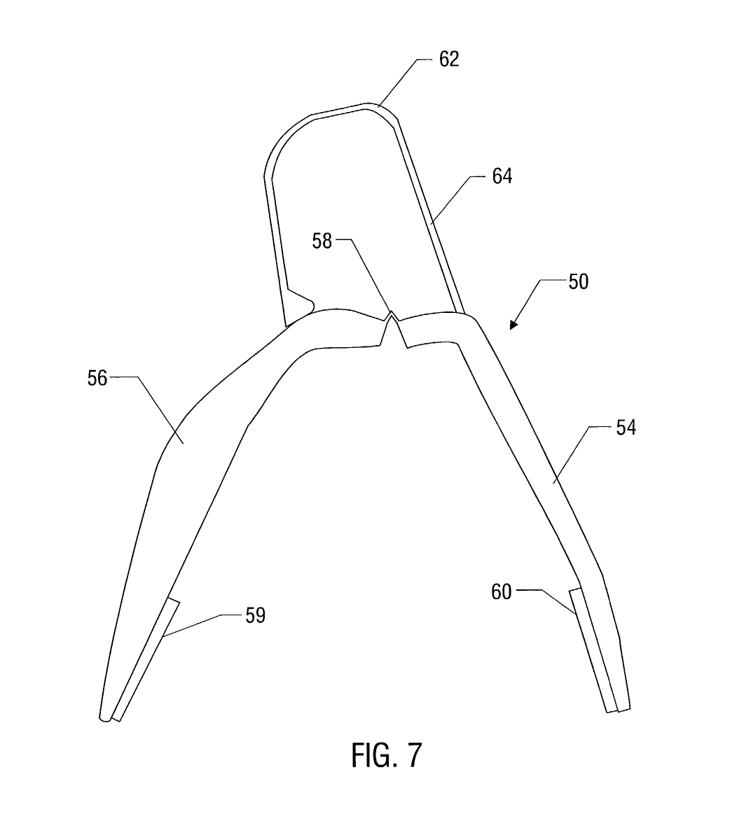

FIGS. 6 and 7 illustrate an alternative embodiment. A binder clip 50 comprises a flexible, U-shaped gripping jaw or support which comprises a back gripping member 54 connected to a front gripping member 56 by a flexible hinge 58. The gripping jaws or supports are preferably made of injection molded plastic. The interior gripping surfaces 59 and 60 are preferably designed to grip paper by one or more flat or arcuate surfaces which do not mark paper. The gripping surfaces should be a design to avoid damage to the paper to be bound.

The spring 62 is held to the binder clip 50 by a back spring leg 64 which slides along a channel 63 in the back of gripping member 54. Back gripping member 54 has a slat 66 across the channel 63 which holds the spring leg 64 in place by a projection 68 on the leg 64. Projection 68 is designed to flex slat 66 outwardly on entry during manufacature but to catch slat 66 across channel 63 and avoid disconnection of the spring 62 from the gripping member 54 when the clip 50 is open.

Alternatively, the binder clip of the invention can be made without a mechanism for keeping the parts together. The spring clip and gripping jaws or support could be made as separate parts and then assembled at the time of use by the user.

The spring clip can also have a central projection which snaps into a central longitudinal groove on the back of the clamp and is retained by such a mechanism. Thus, the spring clip could slide up and down along the back of the clamp to open or shut the clamp. Other parts and functions can be similar to those previously described.

Typical specifications for a binder clip follow. The clip can be 1.75″ wide× 1.375″ long× 0.50″ thick (no paper)×1.00″ thick (100 sheets of paper). The opening of the clip for 100 sheets is 0.4″. The thickness of clip body is 0.08″ thick. The material can be C-1500 series semi-rigid urethane plastic with impact resistance, it is black in color, and hardness of D 70. It is a Smooth-On product distributed by Reynolds Advanced Materials.

The flexible hinge allows flat jaws with grip rubber surfaces to expand and flatten out on various paper quantities installed between them. The grip rubber material, PMC-121/30, is the strongest soft urethane rubber available with a hardness of A 30. The urethane rubber is also produced by Smooth-On. The hinge thickness is 0.005″ and 0.125″ wide between upper and lower clip jaws. The hinge material is the same as for the clip.

The clip may be annotated with O for open and C for closed when operating the clip for paper insertion. The clip spring may be shaped for maximum spring load at 100 sheets of paper. Cycle times are undetermined for maximum use, but similar designs have been cycled over 10,000 times. Material description for the clip is rigid, black in color, with a hardness of D 83-85. It can be polyurethane produced by Camattini, a division of Nest Technologies. The spring can be 0.08″ thick measuring 1.36″ long and 0.375″ wide at slide and 0.5″ wide at push annotation side to prevent rocking of the spring back and forth in slide channel.

Prototypes for the clip have been made of a vulcanized urethane plastic with an approximate durometer hardness of D70 resembling stiff plastics like ABS. Colors can be pigmented or mixed prior to mold injection. Prototypes for the spring have been made of a vulcanized urethane plastic with D95 hardness with a flexural spring or give of 18%.

The clip is auto adjustable with a flexible hinge to accept various quantities of paper without distorting or marring paper surface when in contact with the clips rubber surfaces. In use, paper is held in one hand and the clip in the other. Paper is inserted between clip rubber surfaces while pushing the clip spring forward in direction of close. Prior to closure of the spring, the clip is held with the flexible hinge against the palm, thumb on clip annotation, with four fingers stabilizing the clip on bottom for paper insertion. By pulling back on the spring the clip will open to accept paper. By moving the clip to a closed position, the clip will bind the sheets of paper or other items.

Modifications may be made by persons skilled in the art to the above described illustrative embodiments without departing from the principles, concepts, and equivalents which are involved in the binder of the invention.

What is claimed is:

1. A single binder which is finger-actuated for holding one or more entities and is finger-releasable to release such entities, which single binder comprises:
(1) a clamp having opposing jaws attached along a rotatable joint, the back side of the clamp having a slideway which is substantially perpendicular to the axis of rotation of the joint and the front side having a ramp on its outer surface; and
(2) a closing spring connected to the clamp along one or more surfaces which mate with the slideway to form a slideable connection substantially perpendicular to the axis of rotation of the joint between an open position where the clamp is open and a closed position when the spring is slid over the ramp to force the clamp into a closed, binding position;
(3) the opposing jaws having opposing gripping surfaces which are substantially smooth and which grip the one or more entities by substantially non-marking friction; and
(4) the spring being releasable by finger actuation to slide the spring back over the ramp to free the clamp from its closed binding position.

2. The binder of claim 1 in which the opposing gripping surfaces are free of teeth.

3. The binder of claim 1 in which at least one of the opposing gripping surfaces is substantially flat.

4. The binder of claim 1 in which at least one of the opposing gripping surfaces has an arcuate shape.

5. The binder of claim 1 in which the clamp including the joint is composed of a hard plastic material and the spring is composed of hard plastic having elasticity to form a spring.

6. The binder of claim 5 in which the gripping surfaces are layers of a plastic gripping material which is different from the hard plastic material of the clamp.

7. The binder of claim 1 in which the slideway has one or more stops near the rotatable joint to keep the spring from becoming disconnected from the clamp.

8. The binder of claim 1 in which the slideway is a channel having opposing side grooves and the spring slides along the channel and has ears which slide in the opposing side grooves.

9. The binder of claim 8 in which the opposing side grooves have stops near the joint to keep the ears and the spring from escaping the slideway.

10. The binder of claim 9 in which the spring has space between the ears to allow the ears to be flexed and moved past the stops to enter the grooves.

11. The binder of claim 1 in which the ramp has a detent and the spring has a catch which engages the detent to hold the spring against the clamp in the closed position.

12. The binder of claim 1 in which the clamp is shaped for finger-actuation and the front side of the clamp beyond the ramp has a recessed surface to enhance access to the spring for thumb-actuation to release the spring from the ramp and free the clamp from its closed binding position.

13. The binder of claim 1 in which the clamp including the joint is a single molding of plastic material.

14. The binder of claim 1 in which the binder is a single entity composed of the clamp and the spring.

15. A binder which is finger-actuated for holding one or more entities and is finger-releasable to release such entities, which binder is a single entity composed of:
(1) a clamp having opposing jaws attached along a rotatable joint, the back side of the clamp having a slideway which is substantially perpendicular to the axis of rotation of the joint and the front side having a ramp on its outer surface; and
(2) a closing spring connected to the clamp along one or more surfaces which mate with the slideway to form a slideable connection substantially perpendicular to the axis of rotation of the joint between an open position where the clamp is open and a closed position when the spring is slid over the ramp to force the clamp into a closed, binding position;
(3) the opposing jaws having opposing gripping surfaces which grip the one or more entities by substantially non-marking friction;
(4) the spring being releasable by finger actuation to slide the spring back over the ramp to free the clamp from its closed binding position; and
(5) the clamp including the joint is composed of a single hard plastic molding and the spring is composed of a single plastic molding having elasticity to form a spring.

16. The binder of claim 15 in which the gripping surfaces are layers of a plastic gripping material which is different from the hard plastic material of the clamp.

17. The binder of claim 15 in which the slideway has one or more stops near the rotatable joint to keep the spring from becoming disconnected from the clamp.

18. The binder of claim 17 in which the slideway is a channel having opposing side grooves and the spring slides along the channel and has ears which slide in the opposing side grooves.

19. The binder of claim 18 in which the spring has space between the ears to allow the ears to be flexed and moved past the stops to enter the grooves.

20. The binder of claim 19 in which the ramp has a detent and the spring has a catch which engages the detent to hold the spring against the clamp in the closed position, and the clamp is shaped for finger-actuation and the front side of the clamp beyond the ramp has a recessed surface to enhance access to the spring for thumb-actuation to release the spring from the ramp and free the clamp from its closed binding position.
